(19) United States
(12) Patent Application Publication
(10) Pub. No.: US 2004/0168203 A1
(43) Pub. Date: Aug. 26, 2004

(54) Method and apparatus for presenting video data in synchronization with text-based data

(76) Inventors: Kang Soo Seo, Kyunggi-do (KR); Byung Jin Kim, Kyunggi-do (KR); Soung Hyn Um, Kyunggi-do (KR); Jea Yong Yoo, Seoul (KR); Tae Ho Kim, Seoul (KR); Chang Bum Kim, Seoul (KR)

Correspondence Address: HARNESS, DICKEY & PIERCE, P.L.C., P.O. BOX 8910, RESTON, VA, 20195, US

(21) Appl. No.: 10/730,929

(22) Filed: Dec. 10, 2003

(30) Foreign Application Priority Data
Dec. 12, 2002 (KR) 10-2002-0079375

(51) Int. Cl. H04N 7/16; H04N 7/00; H04N 11/00

(52) U.S. Cl. 725/135; 725/136; 348/461; 348/468

(57) ABSTRACT

A method and apparatus for presenting video data recorded on a recording medium in synchronization with text-based data is disclosed. The video data recorded on the recording medium is reproduced and presented based on video presentation reference time synchronized with program clock reference (PCR) included in the video data and the text-based data is presented based on text presentation reference time. If the presentation position of the video data changes discontinuously, the text presentation reference time as well as the video presentation reference time is adjusted accordingly.

### FOREIGN PRIORITY

The present invention claims priority under 35 U.S.C. 119 on Korean Application No. 10-2002-0079375 filed Dec. 12, 2002; the contents of which are incorporated by reference in their entirety.

### BACKGROUND OF THE INVENTION

1. Field of the Invention

The present invention relates to a method and apparatus for presenting video data recorded on a recording medium such as a Blu-ray Disk-ROM disk in synchronization with text-based data related to the video data.

2. Description of the Related Art

The standardization of new high-density read only and rewritable optical disks capable of recording large amounts of high-quality video and audio data has been progressing rapidly and new optical disk related products are expected to be commercially available on the market in the near future. The Blu-ray Disc Rewritable (BD-RE) and Blu-ray Disk ROM (BD-ROM) are examples of these new optical disks.

A/V data is recorded as a transport stream (TS) on an optical disk as shown in FIG. 1. Transport packets (TPs) constituting the transport stream (TS) contain program clock reference (PCR) and the time duration between two successive PCRs is less than a prescribed limit (e.g., 0.7 s).

The PCR information is recovered from the transport packets (TPs) by a decoding apparatus and used to synchronize the system timing clock (STC) of the decoding apparatus with TS.

For example, suppose that the difference between two successive PCRs is 0.5 sec. If the difference between two successive STC counts obtained at the time when the two PCRs are received is greater than 0.5 sec, the decoder reduces the STC frequency. Likewise, if the difference between two successive STC counts is less than 0.5 sec, the decoder increases the STC frequency.

The presentation time stamps (PTSs) included in the transport packets (TPs), which specify the system time at which corresponding PES packets are to be presented, are compared with the STC counts and the PES packets are decoded and presented based on the comparison result.

The optical disk may include additional text-based data such as subtitle data stored in a data file. The text-based data is auxiliary data related to the A/V data stored on the optical disk. The text-based data may be pre-recorded on the optical disk or may be downloaded to the decoding apparatus through a network at the request of the decoding apparatus.

Because the text-based data is auxiliary data for the main A/V data, the text-based data generally does not provide PCR information and only includes presentation time stamp information for each data unit as shown in FIG. 1.

The PTS of A/V data recorded on the optical disk may not share the same reference time with the PTS of the text-based data in that the text-based data may be provided separately or newly updated. The A/V data needs to be presented in synchronization with the related text-based data even in this case.

The presentation point of the A/V data may be changed by a trick play requested by the user. In this case, the data unit of the text-based data to be presented needs to be changed accordingly.

### SUMMARY OF THE INVENTION

It is an object of the present invention to provide a method and apparatus that is capable of synchronizing text-based data having no PCR information with A/V data having PCR information recorded on an optical disk for presentation of the A/V data along with the related text-based data.

It is another object of the present invention to provide a method and apparatus for adjusting presentation reference time of text-based data with a view to synchronizing the text-based data with the A/V data if the presentation point of the A/V data changes.

A method for presenting video data in synchronization with text-based data in accordance with the present invention comprises the steps of (a) generating video presentation reference time synchronized with program clock reference (PCR) included in a video data stream reproduced from a recording medium, (b) generating text presentation reference time by adding an offset value to the video presentation reference time, and (c) presenting the video data stream and text-based data simultaneously, the video data stream being presented based on the video presentation reference time and the text-based data being presented based on the text presentation reference time.

Another method for presenting video data in synchronization with text-based data in accordance with the present invention comprises the steps of (a) presenting video data recorded on a recording medium in synchronization with text-based data, the video data being presented based on video presentation reference time and the text-based data being presented based on text presentation reference time and (b) resetting the text presentation reference time if the presentation position of the video data changes discontinuously.

An apparatus for presenting video data in synchronization with text-based data in accordance with the present invention comprises a first means for generating video presentation reference time synchronized with program clock reference included in a video data stream reproduced from a recording medium, a vide decoder for decoding the video data stream based on the video presentation reference time, a second means for generating text presentation reference time by adding an offset value to the video presentation reference time, a text decoder for decoding the text-based data based on the text presentation reference time, and a mixer for mixing the output of the video decoder with the output of the text decoder.

### BRIEF DESCRIPTION OF THE DRAWINGS

The above features and other advantages of the present invention will be more clearly understood from the following detailed description taken in conjunction with the accompanying drawings, in which:

FIG. 1 illustrates MPEG2 transport stream A/V data recorded on an optical disk and text-based data to be presented along with the A/V data;

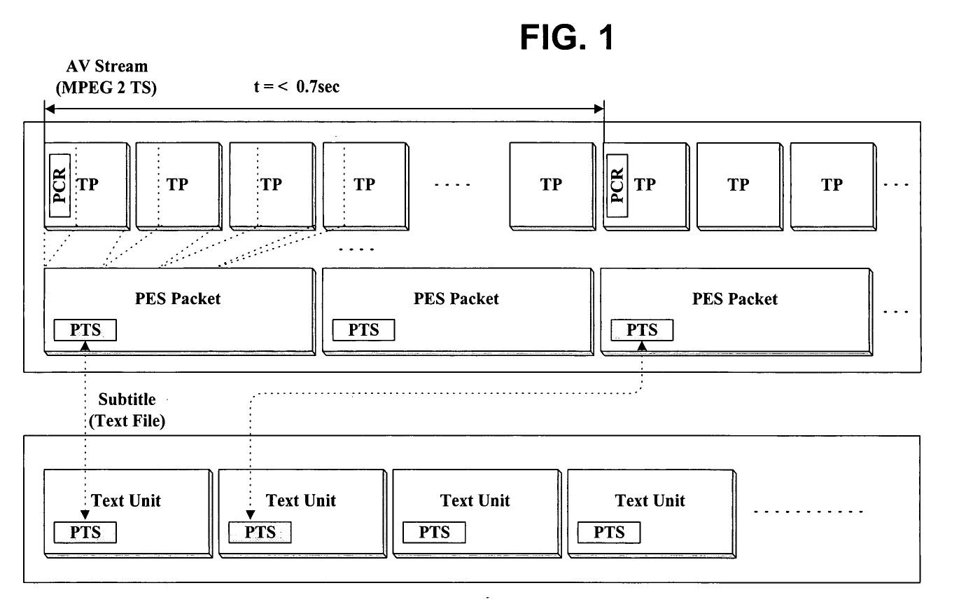

FIG. 2 illustrates a block diagram of a decoding apparatus in which the present invention may be advantageously embodied;

FIG. 3 illustrates an example in which the presentation reference time needs updating; and

FIGS. 4a and 4b illustrate examples of the text data having no PCR information in accordance with the invention.

### DETAILED DESCRIPTION OF THE PREFERRED EMBODIMENTS

In order that the invention may be fully understood, preferred embodiments thereof will now be described with reference to the accompanying drawings.

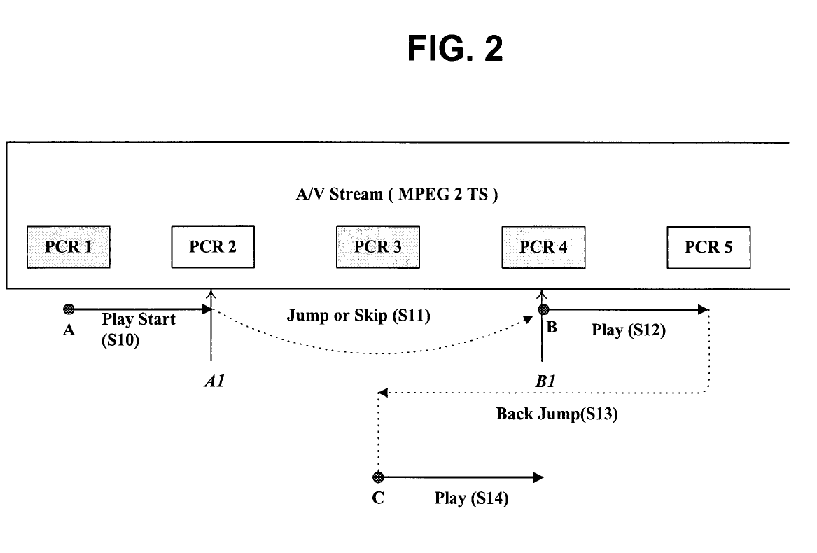

FIG. 2 illustrates a brief block diagram of a decoding apparatus in which the present invention may be advantageously embodied. The decoding apparatus comprises a TS demux 20 for demultiplexing an input transport stream (TS), an STC controller 21 for synchronizing the STC of the apparatus with the PCR included in the TS and for providing A/V presentation reference time (AV PRT) by counting the STC, an audio decoder 22 and video decoder 23 for decoding audio and video elementary streams from the TS demux 20, a text interpreter 26 for interpreting input subtitle data, a text renderer 27 for converting the text data into graphic data based on the interpreted text information (e.g., color, position, color depth), a reference time compensator 25 for adjusting the A/V presentation reference time (AV PRT) to text data presentation reference time (TX PRT), a mixer 24 for mixing the decoded video signal with the rendered text, and a controller 30 for controlling the reference time adjustment operation and decoding and presentation of the data. The function of the apparatus may be implemented by firmware rather than by hardware components.

An MPEG2 transport stream (TS) reproduced from an optical disk loaded into the decoding apparatus is demultiplexed into a video elementary stream and an audio elementary stream by the TS demux 20 and transport packets (TPs) including PCR information are recovered from the elementary streams. The video and audio elementary streams are decoded by the video decoder 22 and audio decoder 23, respectively. When to decode each data packet is determined by comparing the A/V presentation reference time (AV PRT) provided by the STC controller 21 with PTS information included in each elementary stream.

The reference time compensator 25 outputs the text presentation reference time (TX PRT) by calculating it using the A/V presentation reference time (AV PRT) provided by the STC controller 21 and an offset time provided by the controller 30.

The offset time is the difference between the initial PTS of the A/V data included in the navigation DB of the optical disk and the initial PTS of the text data. The initial PTS of the text data is provided by the text interpreter 26.

For example, if the initial PTS of the A/V data is 100 and the initial PTS of the text data is 1000, the offset time amounts to 900. In this case, receiving an A/V presentation reference time (AV PRT), the reference time compensator 25 outputs a text presentation reference time (TX PRT), which is the A/V presentation reference time (AV PRT)+900. The text renderer 27 converts the text data into graphic data based on the comparison of the text presentation reference time (TX PRT) and PTS of each text unit, thereby presenting a text unit having a presentation time stamp of PTS1+1000 and video data having a presentation time stamp of PTS1+100 simultaneously. In other words, the text unit and the video data are presented together when the same amount of time (i.e., PTS1) has elapsed since the beginning of the presentation.

The initial PTS, which is the reference time for presenting the text data, may be stored in the header of the text data file or in a separate file.

If the user changes the presentation point of the A/V data while the A/V data is being presented along with the related text data, the text presentation reference time (TX PRT) as well as the A/V presentation reference time (A/V PRT) needs to be updated so that the presentation point of the text data may be changed accordingly.

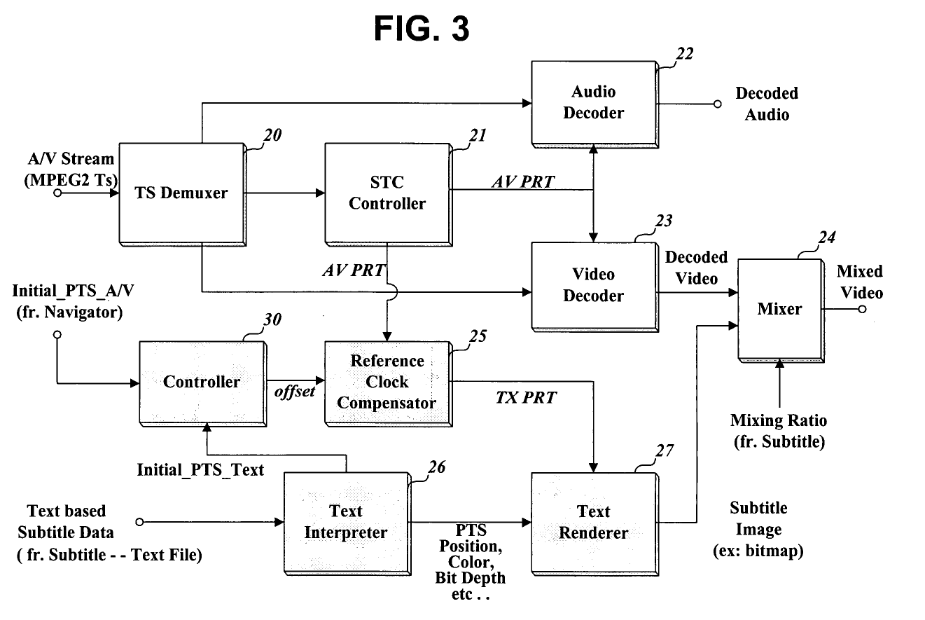

FIG. 3 illustrates an example in which the presentation reference time needs to be updated. The presentation reference time needs to be reset at A at which the presentation operation begins, at B at which the presentation operation resumes after a forward jump, and at C at which the presentation operation resumes after a backward jump. In each case, the PCR value inputted to the STC controller 21 (PCR1, PCR2, or PCR3 in FIG. 3) is loaded into the STC count and the new STC count is used as the A/V presentation reference time (AV PRT).

After the A/V presentation reference time (AV PRT) is reset, the offset time is added to the A/V presentation reference time (AV PRT) by the reference time compensator 25 to create new text presentation reference time (TX PRT), which is provided to the text renderer 27.

In the above example in which the offset time is 900, if a jump occurs from A1 to B1 in FIG. 3, the A/V presentation reference time (AV PRT), which was PCR2, is set to PCR4 and the text presentation reference time (TX PRT), which was PCR2+900, is set to PCR4+900. As a result, a PES packet having a PTS identical to PCR4 is presented along with subtitle data having a PTS identical to PCR4+900 by the audio decoder 22, the video decoder 23, and the text renderer 27.

After the A/V presentation reference time (AV PRT) is reset, the STC controller 21 continues to count the STC, starting from the new value.

Instead of creating text presentation reference time (TX PRT) by adding an offset to the A/V presentation reference time (AV PRT) as done above, the initial PTS of the text data may be made identical to the initial PTS of the A/V data when the text data is received or recorded. In this case, only one presentation reference time, that is, the A/V presentation reference time (AV PRT) is required.

When text-based subtitle is downloaded into the decoding apparatus through a network such as the Internet, it is examined whether the initial PTS of the text data is equal to the initial PTS of the A/V data recorded on the optical disk. If not, the difference is compensated for before the PTS of each text unit is recorded.

In the above example in which the initial PTS of the text data is greater than the initial PTS of the A/V data by 900, 900 is subtracted from the PTS of each data unit and the new PTS is recorded.

It takes a significant amount of time for a human viewer to perceive the text data when the text data is displayed on a screen. Therefore, the resolution of the text presentation reference time (TX PRT) provided by the reference time compensator 25 is not so critical and does not have to be the same as the resolution of the A/V presentation reference time (AV PRT).

The A/V presentation reference time (AV PRT) is of 32-bit length and has a resolution of 90 KHz, which is obtained by dividing 27 MHz by 300, but on the other hand the text presentation reference time (TX PRT) may have a resolution of several milliseconds, which can be easily obtained by general microprocessors. Therefore, the STC controller 21 may generate the text presentation reference time (TX PRT) by masking some less significant bits of the 32-bit A/V presentation reference time (AV PRT)

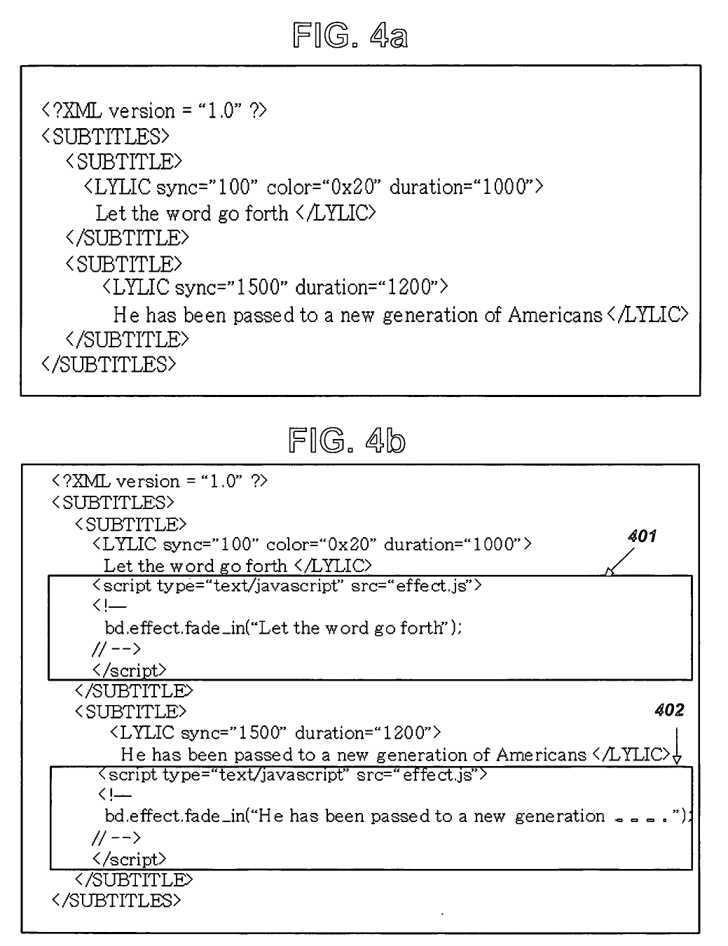

In the above, subtitle data was mentioned as text data having no PCR information. FIGS. 4a and 4b illustrate examples of the subtitle data. The subtitle data is recorded as a text file of the ‘xml’ format, which is one of mark-up languages. As shown in FIG. 4a, the xml format subtitle data includes a plurality of <SUBTITLE> tags and a <SUBTITLE> section may include PTS information (LYLIC sync=“100”), color information (color=“0×20”), presentation duration information (duration=“1000”), etc.

And as shown in FIG. 4b, the subtitle data may include script commands (401, 402) for providing the text with various display effects such as fade-in/out.

The method and apparatus for presenting video data in synchronization with text-based data in accordance with the invention is capable of precisely synchronizing the video data with the related text-based data having no PCR information even after a trick play or a discontinuous change of the presentation position of the video data.

While the invention has been disclosed with respect to a limited number of embodiments, those skilled in the art, having the benefit of this disclosure, will appreciate numerous modifications and variations therefrom. It is intended that all such modifications and variations fall within the spirit and scope of the invention.

What is claimed is:

1. A method for presenting video data in synchronization with text-based data, comprising the steps of:
generating video presentation reference time synchronized with program clock reference (PCR) included in a video data stream reproduced from a recording medium;
generating text presentation reference time by adding an offset value to the video presentation reference time; and
presenting the video data stream and text-based data simultaneously, the video data stream being presented based on the video presentation reference time and the text-based data being presented based on the text presentation reference time.

2. The method set forth in claim 1, wherein the offset value is the difference between the initial presentation time stamp (PTS) of the video data stream and the initial presentation time stamp (PTS) of the text-based data.

3. The method set forth in claim 1, wherein the text-based data does not include program clock reference (PCR) information.

4. The method set forth in claim 1, wherein the text-based data is subtitle data written in a mark-up language.

5. The method set forth in claim 1, wherein the resolution of the text presentation reference time is lower than the resolution of the video presentation reference time.

6. The method set forth in claim 5, wherein the resolution of the text presentation reference time is of the order of several milliseconds.

7. The method set forth in claim 1, wherein the text-based data is recorded on the recording medium or provided by an external source through a network.

8. A method for presenting video data in synchronization with text-based data, comprising the steps of:
presenting video data recorded on a recording medium in synchronization with text-based data, the video data being presented based on video presentation reference time and the text-based data being presented based on text presentation reference time; and
resetting the text presentation reference time if the presentation position of the video data changes discontinuously.

9. The method set forth in claim 8, wherein the video presentation reference time is synchronized with program clock reference included in the video data.

10. The method set forth in claim 8, wherein the resetting step resets the video presentation reference time and resets the text presentation reference time by adding an offset value to the reset video presentation reference time if the presentation position of the video data changes discontinuously.

11. The method set forth in claim 10, wherein the offset value is the difference between the initial presentation time stamp (PTS) of the video data stream and the initial presentation time stamp (PTS) of the text-based data.

12. The method set forth in claim 10, wherein the video presentation reference time is reset to a program clock reference (PCR) value included in video data reproduced from the new presentation position determined by the discontinuous change.

13. The method set forth in claim 8, wherein the text-based data does not include program clock reference (PCR) information.

14. The method set forth in claim 8, wherein the resolution of the text presentation reference time is lower than the resolution of the video presentation reference time.

15. An apparatus for presenting video data in synchronization with text-based data, comprising:
a first means for generating video presentation reference time synchronized with program clock reference included in a video data stream reproduced from a recording medium;
a vide decoder for decoding the video data stream based on the video presentation reference time;
a second means for generating text presentation reference time by adding an offset value to the video presentation reference time;
a text decoder for decoding the text-based data based on the text presentation reference time; and
a mixer for mixing the output of the video decoder with the output of the text decoder.

16. The apparatus set forth in claim 15, wherein the first means resets the text presentation reference time if the presentation position of the video data stream changes discontinuously.

17. The apparatus set forth in claim 16, wherein the first means resets the video presentation reference time to a program clock reference (PCR) value included in the video data stream reproduced from the new presentation position determined by the discontinuous change.

18. The apparatus set forth in claim 15, wherein the offset value is the difference between the initial presentation time stamp (PTS) of the video data stream and the initial presentation time stamp (PTS) of the text-based data.

19. The apparatus set forth in claim 15, wherein the resolution of the text presentation reference time is lower than the resolution of the video presentation reference time.
